(19) United States
(12) Patent Application Publication
(10) Pub. No.: US 2020/0249196 A1
(43) Pub. Date: Aug. 6, 2020

(54) ION CONCENTRATION SENSOR

(71) Applicant: SHARP KABUSHIKI KAISHA, Sakai City, Osaka (JP)

(72) Inventors: YUKI EDO, Sakai City (JP); YUKIO TAMAI, Sakai City (JP); SHINOBU YAMAZAKI, Sakai City (JP); TOSHIO YOSHIDA, Sakai City (JP); YOSHIMITSU NAKASHIMA, Sakai City (JP)

(73) Assignees: SHARP KABUSHIKI KAISHA, Sakai City, Osaka (JP); SHARP KABUSHIKI KAISHA, Sakai City, Osaka (JP)

(21) Appl. No.: 15/776,063

(22) PCT Filed: Oct. 4, 2016
(86) PCT No.: PCT/JP2016/079416

§ 371 Date: May 14, 2018

(30) Foreign Application Priority Data
Nov. 27, 2015 (JP) 2015-232215

(51) Int. Cl. G01N 27/414

(52) U.S. Cl. CPC G01N 27/414

(57) ABSTRACT

In an ion concentration sensor, both an improvement of an SN ratio of output and high responsiveness are achieved. In an ion sensor (100), a sensing unit (1) accumulates as electron injected from an n-type substrate (21) via a p-well (22) as a signal charge. The p-well (22) is laminated on the n-type substrate (21). A concentration distribution of impurities exists in the p-well (22) located between the sensing unit (1) and the n-type substrate (21), and a maximum value C1 of an impurity concentration in the p-well (22) is 0<C1≤3.0×10¹⁴ cm³.

### TECHNICAL FIELD

The present invention relates to an ion concentration sensor that detects an ion concentration in accordance with. a potential change on a surface of a sensing unit sensitive to ions.

### BACKGROUND ART

In recent years, in order to quantitatively measure a physical phenomenon. or a chemical phenomenon, various measurement apparatuses are proposed. An ion concentration sensor is actively developed as one such measurement apparatus.

As an example, PTL 1 discloses a measurement apparatus (ion concentration sensor) with an objective of improving (accelerating) responsiveness of measurement. In the measurement apparatus of PTL 1, supply of signal charges (for example, electrons) to a sensing unit is shared by a plurality of charge supply units. As a result, charge supply to the sensing unit is accelerated, and the responsiveness of the measurement by the measurement apparatus is improved.

### CITATION LIST

### Patent Literature

PTL 1: Japanese Unexamined Patent Application Publication No. 2005-337806 (published Dec. 8, 2005)

### Non Patent Literature

NPL 1: “Key points of semiconductor device”, [online], HIROSE, Fumihiko, Jan. 6, 2013, [searched. November 19, Heisei 27], Internet <URL:http://fhirose.yz.yamagata-u.ac.jp/text/kisol.pdf>

NPL 2: DANIEL L. MEIER, JEONG-MO HWANG, and ROBERT B. CAMPBELL, “The Effect of Doping Density and Injection Level on Minority-Carrier Lifetime as Applied to Bifacial Dendritic Web Silicon Solar Cells”, IEEE TRANSACTIONS ON ELECTRON DEVICES, VOL. ED NO. I, JANUARY 1988.

### SUMMARY OF INVENTION

### Technical Problem

Incidentally, in recent years, since high integration of ion concentration sensor has advanced, it is necessary to cope with the problems caused by the high integration of the ion concentration sensor.

In particular, in an ion concentration sensor having fine cells (for example, cells of 10 μm or less) integrated at a high density, an area of a sensing unit is very small in order to miniaturize the cells. Therefore, it is necessary to improve an SN ratio of output of an ion sensor by repeating a reading of signal charges from the sensing unit a plurality of times (approximately 10 to 100 times). However, in a case where the reading of the signal charges is repeated, there is a problem that responsiveness is deteriorated.

In this manner, in order to appropriately cope with high. integration of the ion concentration sensor, it is desired to achieve both improvement of the SN ratio of output and high responsiveness.

An object of the present invention is to provide an ion concentration sensor capable of achieving both an improvement of an SN ratio of output and high responsiveness.

### Solution to Problem

In order to solve the above problem, an ion concentration sensor according to one aspect of the present invention is an ion concentration sensor that detects an ion concentration of a measurement target based on a potential change on a surface of a sensing unit sensitive to ions, and includes a substrate to which a donor is added as an impurity, and a p-well to which an acceptor is added as an impurity and that is laminated on the substrate, in which the sensing unit includes a donor added as an impurity and accumulates an electron injected from the substrate via the p-well as a signal charge, and a concentration distribution. of impurities exists in the p-well located between the sensing unit and the substrate, and a maximum value C1 of an impurity concentration in the p-well satisfies a following formula (A1)

0<C1≤3.0×10¹⁴ cm⁻³ (A1).

### Advantageous Effects of Invention

According to the ion concentration sensor of one aspect of the present invention, there is an effect that both the improvement of the SN ratio of output and the high responsiveness can be achieved.

### BRIEF DESCRIPTION OF DRAWINGS

FIG. 1(a) is an enlarged plan view illustrating a portion of an ion sensor according to Embodiment 1 of the present invention, FIG. 1(b) is a cross-sectional view viewed from an arrow direction. of line A-A in FIG. 1(a), and FIG. 1(c) is a cross-sectional view viewed from arrow directions of line B-B and line C-C in FIG. 1(a).

FIG. 2 is a cross-sectional view of a portion of the ion sensor according to Embodiment 1 of the present invention.

FIG. 3 is a timing chart illustrating a relationship between voltages applied to a first gate electrode to a fourth gate electrode and an n-type substrate of the ion sensor according to Embodiment 1 of the present invention.

FIG. 4(a) is a graph illustrating an impurity concentration profile of line X1-X2 in FIG. 2, and FIG. 4(b) is a graph illustrating a potential profile corresponding to FIG. 4(a).

FIG. 5(a) is a graph illustrating a potential profile of line Y1-Y2 in FIG. 2, and FIG. 5(b) is a graph illustrating a potential profile corresponding to FIG. 5(a).

FIG. 6 is a graph illustrating a relationship between an injection time of electrons and the number of injected electrons of the ion sensor according to Embodiment 1 of the present invention.

FIG. 7 is a graph illustrating a relationship between the number of signal reading and a frame rate of the ion sensor according to Embodiment 1 of the present invention.

FIG. 8 is a graph illustrating a relationship between an impurity concentration of a semiconductor material and a diffusion coefficient.

FIG. 9 is a graph illustrating a relationship between a carrier concentration of the semiconductor material and a carrier lifetime.

FIG. 10 are graphs illustrating drive patterns of the ion sensors in Embodiments 1 and 2 of the present invention, FIG. 10(a) is a graph illustrating a drive pattern (drive pattern 1) in Embodiment 1, and FIG. 10(b) is a graph illustrating a drive pattern (drive pattern 2) in Embodiment 2.

FIG. 11 is a graph illustrating potential profiles of Y1-Y2 line in FIG. 2 in a case of each drive pattern 1 and 2.

FIG. 12 is a cross-sectional view of a portion of an ion sensor according to Embodiment 3 of the present invention.

FIG. 13 is a graph illustrating an example of a potential profile of line X1-X2 in FIG. 2.

FIG. 14(a) is a graph illustrating an example of an impurity concentration profile of line Z1-Z2 in FIG. 12, and FIG. 14(b) is a graph illustrating a potential profile corresponding to FIG. 14(a).

FIG. 15(a) is a graph illustrating another example of the impurity concentration profile of line Z1-Z2 in FIG. 12, and 15(b) is a graph illustrating a potential profile corresponding to FIG. 15(a).

FIG. 16(a) is a plan view schematically illustrating an overall configuration of the ion sensors according to Embodiments 1 to 3 of the present invention, and FIG. 16(b) is a cross-sectional view of a portion in FIG. 16(a).

FIG. 17 are graphs illustrating potential profiles of line X1-X2 in FIG. 2, FIG. 17(a) is a graph illustrating a potential profile at a position Rc in FIG. 16, and FIG. 17(b) is a graph illustrating a potential profile at a position Ro in FIG. 16.

FIG. 18 is a cross-sectional view of a portion of an ion sensor according to Embodiment 4 of the present invention.

FIG. 19(a) is a plan view schematically Illustrating an overall configuration of a configuration of an ion. sensor according to Embodiment 5 of the present invention, and FIG. 19(b) is an enlarged view of a region P in FIG. 19(a).

FIG. 20 is a cross-sectional view of a portion of the ion sensor according to Embodiment 5 of the present invention.

FIG. 21(a) is a graph illustrating an example of an impurity concentration profile of line W1-W2 in FIG. 20, and FIG. 21(b) is a graph illustrating a potential profile corresponding to FIG. 21(a).

FIG. 22 is a view illustrating an example of measurement using the ion sensor according to Embodiment 5 of the present invention.

### DESCRIPTION OF EMBODIMENTS

### Embodiment 1

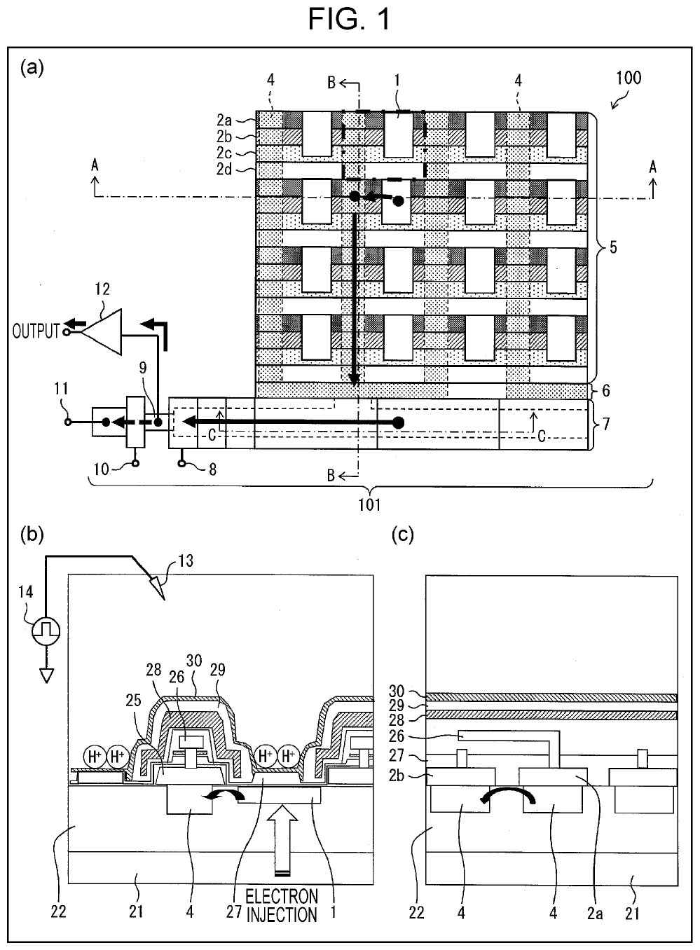

Hereinafter, Embodiment 1 of the present invention will be described in detail with reference to FIGS. 1 to 9. As described below, an ion concentration sensor according to one aspect of the present invention is an ion concentration sensor that detects an ion concentration of a measurement target based on a potential change on a surface of a sensing unit sensitive to ions.

The ion concentration sensor according to the aspect of the present invention may be used as a chemical or physical phenomenon detection device that detects a chemical phenomenon or a physical phenomenon accompanied by a change in the ion concentration of the measurement target.

### Outline of Ion Sensor 100

First, an outline of an ion sensor 100 (ion concentration sensor) will be described with reference to FIG. 1. FIG. 1(a) is an enlarged plan view illustrating a portion of the ion sensor 100 according to Embodiment 1, FIG. 1(b) is a cross-sectional view viewed from an arrow direction of line A-A in FIG. 1(a), and FIG. 1(c) is a cross-sectional view viewed from arrow directions of line B-B and line C-C in FIG. 1(a).

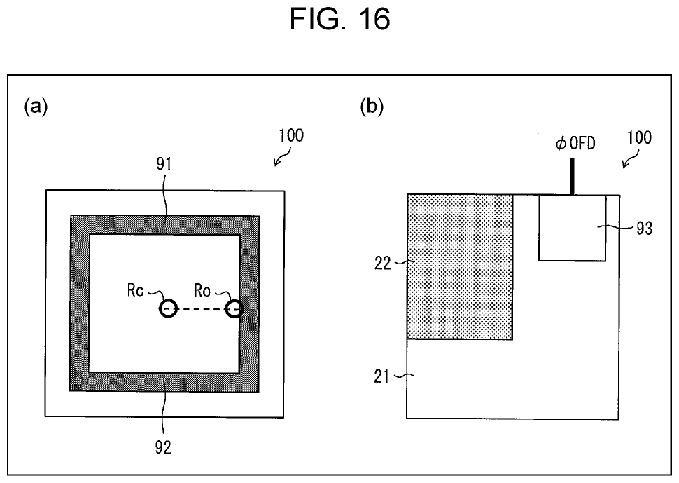

The ion sensor 100 is a photodiode type ion concentration sensor utilizing a charge coupled device (CCD) type image sensor. An overall configuration of the ion sensor 100 may be referred to FIG. 16(a) to be described later.

As illustrated in FIG. 16(a) to be described later, the ion sensor 100 is provided with a pixel region 91. The pixel region 91 forms a recessed. portion, and multiple sensing structures (sensing units 1 illustrated below) are disposed in a matrix shape at a bottom of the recessed portion. A solution serving as a target to be measured (measurement target) for the ion concentration is injected into the pixel region 91.

As described in Embodiment 5 described later, the pixel region can also function as a light-receiving region (reference: pixel region 95 in FIG. 19). A non-light-receiving region 101 serving as a portion not contributing to light reception is formed in a neighbor of the pixel region 91. The non-light-receiving region 101 includes a horizontal transfer unit 7 and the like described later.

As illustrated in FIG. 1(a), the ion sensor 100 is provided with a sensing unit 1, a first gate electrode 2a, and a second gate electrode 2b, a third gate electrode 2c, a fourth gate electrode 2d, a vertical transfer unit 4, an addition unit 6, a horizontal transfer unit 7, an output gate 8, a floating diffusion unit 9, a reset gate 10, a reset drain 11, and an output transistor 12.

In FIG. 1(a), a region where the sensing unit 1, the first gate electrode 2a to the fourth. gate electrode 2d, and the vertical transfer unit 4 are formed is referred to as a measurement region 5. The measurement region 5 may be referred to as a sensor array region.

In the ion sensor 100, the addition unit 6, the horizontal transfer unit 7, the output gate 8, the floating diffusion unit 9, the reset gate 10, the reset drain 11, and the output transistor 12 are formed in the non-light-receiving region 101.

As illustrated in FIGS. 1(b) and 1(c), the ion sensor 100 is provided with a reference electrode 13, a voltage control unit 14, an n-type substrate 21 (substrate), a p-well 22, an electrode 26, a silicon oxide film 27, a light shielding film 28, an insulating film 29, and an ion sensitive film 30.

The sensing unit 1 is a photoelectric conversion unit that converts received light into a charge (performs photoelectric conversion). The sensing unit 1 is formed of a photoelectric conversion element such as a photodiode, for example, and has a diode that accumulates a converted charge. A plurality of sensing units 1 are provided in the ion sensor 100. However, in the ion sensor according to the aspect of the present invention, only one sensing unit may be provided.

The first gate electrode 2a to the fourth gate electrode 2d are gate electrodes for controlling to read the charges accumulated in the sensing unit 1. The first gate electrode 2a to the fourth gate electrode 2d are formed on the vertical transfer unit 4.

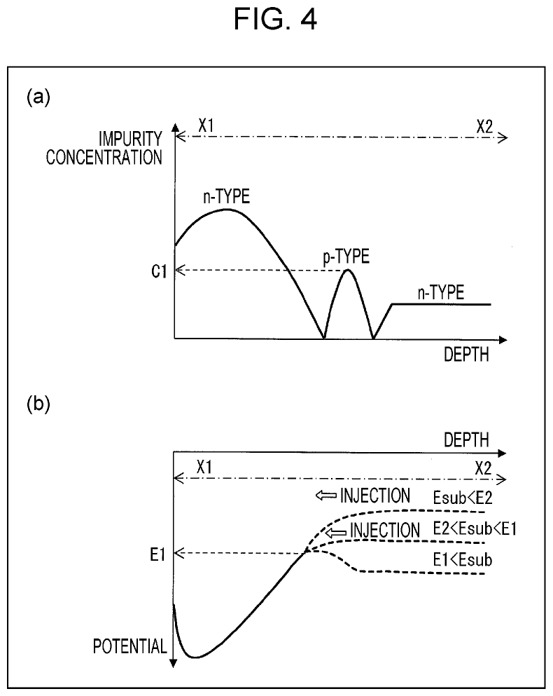

As illustrated in FIG. 3 and the like described later, charge reading is controlled according to the voltages applied to the first gate electrode 2a to the fourth gate electrode 2d (voltage φV1 to φV4 (control voltage)) and the voltage applied to the n-type substrate 21 (voltage φOFD).

More specifically, a voltage φV1 for reading the charge is applied to the first gate electrode 2a. Voltages φV2 to φV4 for transferring charges are applied so the second gate electrode 2b to the fourth gate electrode 2d.

In the present embodiment, although the configuration in which the first gate electrode 2a to the fourth gate electrode 2d are provided for one sensing unit 1 is exemplified, the number of gate electrodes provided for one sensing unit 1 is not limited to four. For example, two gate electrodes of the first gate electrode 2a and the second gate electrode 2b may be provided for one sensing unit 1.

That is, at least one gate electrode to which a voltage for reading charge is applied and at least one gate electrode to which a voltage for transferring charges is applied may be provided in one sensing unit 1.

The vertical transfer unit 4 (charge transfer unit, first charge transfer unit) transfers the read charge in the vertical direction according to the voltage applied to the first gate electrode 2a to the fourth gate electrode 2d. Here, the vertical direction is a direction perpendicular to the longitudinal direction of the horizontal transfer unit 7 described later.

A plurality of the vertical transfer units 4 are provided in parallel along the vertical direction. Here, the number of the vertical transfer unit 4 may be one. It may be understood that the vertical transfer unit 4 is a charge transfer unit further apart from a later-described output unit (not directly connected to the output unit) among the two types of charge transfer units provided in the ion sensor 100. The vertical transfer unit 4 is formed by disposing a plurality of metal oxide semiconductor (MOS) capacitors adjacent to each other.

The addition unit 6 is a portion formed by joining the end portions of the plurality of vertical transfer units 4 and adds the amount of charges transferred by each of the joined vertical transfer units 4.

A cell is configured to include one sensing unit 1, the first gate electrode 2a to a fourth gate electrode 2d corresponding to the sensing unit 1, and a portion of the vertical transfer unit 4 corresponding to the sensing unit 1.

The horizontal transfer unit 7 (charge transfer unit and second charge transfer unit) transfers charges output from the addition unit 6 in the horizontal direction by the same configuration as that of the vertical transfer unit 4. Here, the horizontal direction is the longitudinal direction of the horizontal transfer unit 7. It may be understood that the horizontal transfer unit 7 is a charge transfer unit closer to the output unit (directly connected to the output unit) among the two types of charge transfer units provided in the ion sensor 100.

The output gate 8 is a gate circuit for outputting the charges transferred from the horizontal transfer unit 7 to the floating diffusion unit 9 and outputs charges only when an ON voltage is applied.

The floating diffusion unit 9 has a capacitor including the n-type region, and is a detection unit that detects the charge amount as a voltage by extracting the charge amount of the charged particle outputted from the output gate 8 as a voltage corresponding to the capacitance value of the capacitor.

The reset gate 10 is a portion for resetting the voltage of the cell for which the floating diffusion unit 9 has completed outputting before the voltage for the next cell is outputted.

The reset drain 11 is a portion to which the reset voltage of the floating diffusion unit 9 is applied. The reset gate 10 is in an off state in a state where the floating diffusion unit 9 is detecting charges, but is in an on state in a reset operation. As a result, the floating diffusion unit 9 is reset to the voltage applied to the reset drain 11.

The output transistor 12 functions as an amplifier with a very High input resistance. As a result, the output transistor 12 buffer amplifies the voltage outputted from the floating diffusion unit 9 and outputs the amplified voltage as a signal voltage.

The output gate 8, the reset gate 10, the floating diffusion unit 9, and the output transistor 12 configure the output unit. The output unit is not limited to one location and may be provided at a plurality of locations.

The reference electrode 13 provides a reference potential for determining the potential of the solution to be measured ion concentration. The reference electrode 13 is disposed so as to be in contact with the solution injected into the pixel region 91.

The voltage control unit 14 controls the voltage (reference electrode voltage) applied to the reference electrode 13. The voltage control unit 14 is provided with a drive power supply capable of changing the reference electrode voltage by High speed pulse drive. The voltage control unit 14 is provided with a sensor element for detecting a voltage applied to the first gate electrode 2a, and can change the reference electrode voltage in conjunction with the application of the voltage to the first gate electrode 2a.

When the reference electrode voltage increases, the potential of the sensing unit 1 becomes deep and an upper limit of the charge amount accumulated in the sensing unit 1 increases. Accordingly, by appropriately controlling the reference electrode voltage by the voltage control unit 14, it is possible to suppress deterioration in precision at the time of ion concentration measurement. “Potential of the sensing unit 1 is deep” means that “potential of the sensing unit 1 is High”.

The n-type substrate 21 is a substrate on which each element constituting the ion sensor 100 is provided. The n-type substrate 21 is formed of an n-type semiconductor. An impurity (dopant) such as P (phosphorus) or As (arsenic), for example, may be added to the n-type substrate 21 as a donor.

The p-well 22 is a layer formed of a p-type semiconductor. The p-well 22 is laminated on the n-type substrate 21. An impurity such as B (boron) or Al (aluminum), for example, may be added to the p-well 22 as acceptors. As described later, the p-well 22 is a p-type diffusion region. The diffusion region means a region where a non-uniform concentration distribution of impurities exists.

The sensing unit 1 and the vertical transfer unit 4 are formed at intervals on the side apart from the n-type substrate 21 of the p-well 22, respectively. As will be described later, the sensing unit 1 and the vertical transfer unit 4 are n-type diffusion regions, respectively.

The electrode 26 is an electrode connected to a power supply line (not illustrated). The electrode 26 is formed by bonding to the first gate electrode 2a to the fourth gate electrode 2d. The electrode 26 is configured to include a refractory metal film such as titanium nitride (TiN) or tungsten (W) or a silicide thereof. As a result, since High temperature heat treatment is possible, interface state suppression can be performed and noise is suppressed.

Since the signal delay of the electrode 26 is reduced due to the low resistance of the refractory metal film serving as a material or the suicide thereof, high speed operation is enabled. In addition, since the refractory metal film or the silicide thereof is a material having High light shielding property, entry of optical noise into the re-type substrate 21 can be prevented. It is preferable that electrodes and wiring other than the electrodes 26 included in the ion sensor 100 are also formed of the same material as the electrode 26.

A polysilicon electrode 25 is an electrode provided on the vertical transfer unit 4. The polysilicon electrode 25 is connected to the electrode 26. It may be understood that the polysilicon electrode 25 is an electrode which collectively represents the first gate electrode 2a to the fourth gate electrode 2d.

The light shielding film 28 is a light shielding film formed so as to cover the first gate electrode 2a to the fourth gate electrode 2d and the electrode 26. The insulating film 29 is an insulating film covering the light shielding film 28.

The silicon oxide film 27 is formed on the sensing unit 1. The silicon oxide film 27 suppresses the occurrence of defects caused by the direct contact of the ion sensitive film 30 with the p-well 22 and prevents characteristic deterioration. The silicon oxide film 27 also has a function as a water resistant film which prevents moisture from penetrating into the lower layer portion.

The ion sensitive film 30 has ion sensitivity which changes the potential in the vicinity of the ion sensitive film 30 in the sensing unit 1 according to the ion concentration when the ion sensitive film 30 comes into contact with spec ions. Therefore, depending on the concentration of the specific ions in contact with the ion sensitive film 30, the amount of signal charge that can be accumulated in the sensing unit 1 changes.

As illustrated in FIG. 1(b), in the ion sensor 100, electrons injected from the n-type substrate 21 to the sensing unit 1 via the p-well 22 are accumulated as signal charges. As described above, a voltage φOFD for controlling the injection of electrons from the n-type substrate 21 into the sensing unit 1 is applied to the n-type substrate 21 (refer to also in FIG. 16(b) described later).

In FIG. 1(b), hydrogen ion (H⁺) is exemplified as a specific ion. As an example, pH (hydrogen ion exponent) of the solution can be measured by measuring the hydrogen ion concentration of the solution with the ion sensor 100. However, the above-described specific type of ions is not limited to only hydrogen ions.

### Method of Reading Charges

Subsequently, a method of reading (vertical transfer) the charges from the sensing unit 1 to the vertical transfer unit 4 in the ion sensor 100 will be described. This vertical transfer method is the same as the vertical transfer operation performed in the CCD in the related art.

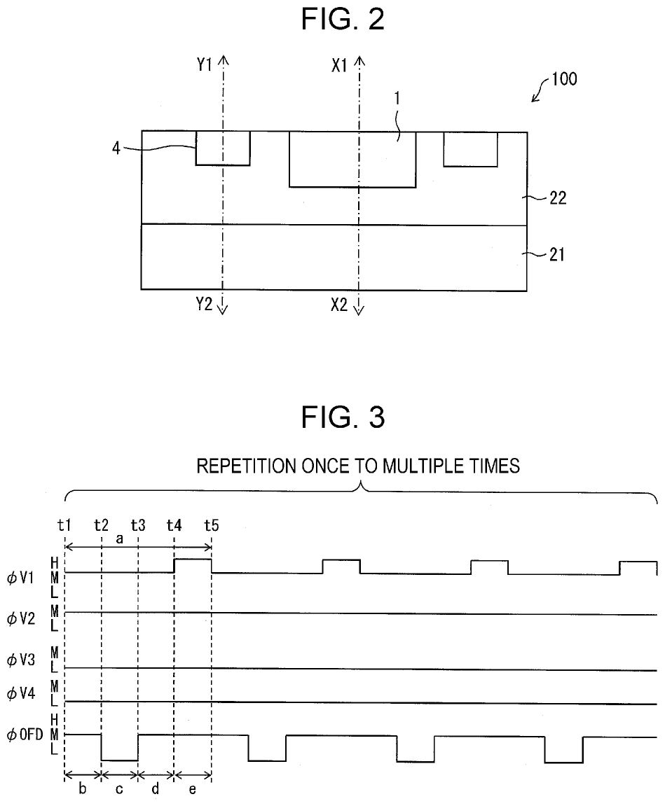

FIG. 2 is a cross-sectional view of a portion of the ion sensor 100. FIG. 2 schematically illustrates the configuration of one pixel of the ion sensor 100. In FIG. 2, the illustration of the polysilicon electrode 25 is omitted.

FIG. 3 is a timing chart illustrating a relationship between voltages applied to the first gate electrode 2a to the fourth gate electrode 2d and the n-type substrate 21. Hereinafter, the voltage applied to the first gate electrode 2a is referred to as φV1, the voltage applied to the second gate electrode 2b is referred to as φV2, the voltage applied to the third gate electrode 2c is referred to as φV3, the voltage applied to the fourth gate electrode 2d is referred to as φV4, and the voltage applied to the n-type substrate 21 is referred to as φOFD. The waveforms of the voltages φV1 to φV4 and OFF) may be generated by a pulse generator, for example.

In FIG. 3, the symbols “H” (High), “M” (Middle) , and “L” (Low) are attached. as symbols representing the levels of the respective voltages.

In FIG. 3, time t1 is an initial time at which reading of the charges starts. Time t2 is a falling time of the voltage φOFD. Time t3 is a rise time of the voltage φOFD. Time t4 is a rise time of voltage φV1. Time t5 is a fall time of voltage φV1.

In FIG. 3, time b is represented as b=t2−t1. It may be understood that this time b is a time at which the initial state (state before the reading of the charges is started) is sustained. Time b may be, for example, approximately 1 μs to 100 μs.

At time b, the voltages φV1 and φV2 are Middle (0 V). Voltage φOFD is Middle (5 V to 20 V). The voltages φV3 and φV4 are maintained constant at Low (−7 V to −6 V) in all time ranges.

Time c is represented as c=t3−t2. This time c is a time when electrons are injected from the n-type substrate 21 to the sensing unit 1. Time c is equal to a pulse width of voltage φOFD. This time c may be referred to as an injection time.

At time c, the voltage φOFD becomes Low (−0.2 V to 0 V). The voltage may be referred to as an injection voltage. At time c, since the potential of the n-type substrate 21 decreases, electrons are injected from the n-type substrate 21 into the sensing unit 1.

Time d is represented as d=t4−t3. This time d is a time (maintained as Middle) until the voltage 00£D returns to Middle and the voltage φV1 changes to High (13 V to 14 V).

At time d, the injection of electrons from the n-type substrate 21 into the sensing unit 1 is stopped, and a state where a predetermined amount of charge is accumulated in the sensing unit 1 is maintained. The time d may be, for example, approximately 1 μs to 100 μs.

Time e is represented as e=t5−t4. This time e is a time during which charges are read from the sensing unit 1 to the vertical transfer unit 4. Time e is equal to a pulse width of the voltage φV1. Time e may be, for example, approximately 5 μs to 20 μs.

At time e, since the voltage φV1 becomes High, a height of the potential barrier between the sensing unit 1 and the vertical transfer unit 4 decreases. Therefore, the charges are read from the sensing unit 1 to the vertical transfer unit 4.

Time a is represented as a=t5−t1. Time a is also represented as a=b+c+d+e. Time a is a time required to perform reading of charges from the sensing unit 1 to the vertical transfer unit 4 once. This time a may be referred to as a reading time.

In the ion sensor 100, the reading of charges described above is repeated a multiple of times (for example, 100 times), and the read charges are accumulated in the vertical transfer unit 4. As a result, the SN ratio of the output (signal voltage) of the ion sensor 100 can be improved.

The charges (in other words, electrons) read into the vertical transfer unit 4 are transferred to the output unit described above via the horizontal transfer unit 7. The time required for this transfer is referred to as a transfer time. The sum of the transfer time and the reading time (time a described above) is referred to as one frame time. A reciprocal of one frame time is referred to as a frame rate.

In a general CCD, the frame rate at the time of reading once is approximately 30 frame per second (fps) to 60 fps. In other words, one frame time in the general CCD is approximately 17 ms to 33 ms.

### Relationship between Injection Time and Voltage Applied to n-Type Substrate 21

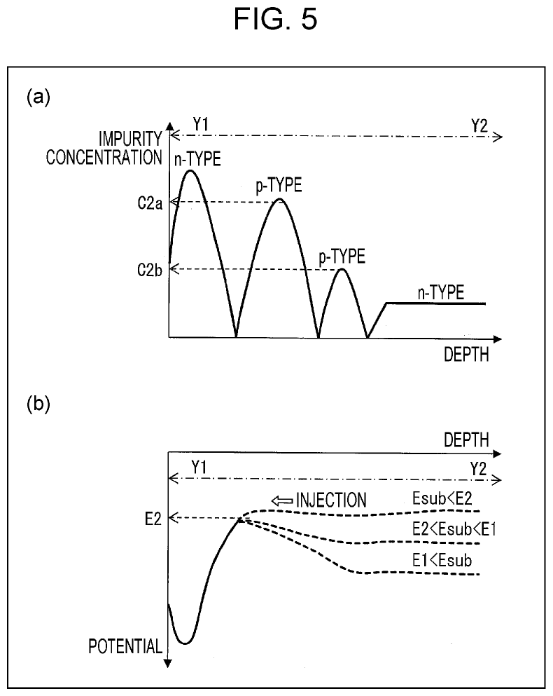

Subsequently, with reference to FIGS. 4 and 5, the relationship between the injection time and the voltage applied to the n-type substrate 21 in the ion sensor 100 will be described.

FIG. 4(a) is a graph illustrating an impurity concentration profile of line X1-X2 in FIG. 2. FIG. 4(b) is a graph illustrating a potential profile corresponding to FIG. 4(a) (that is, potential profile of line X1-X2 in FIG. 2).

FIG. 5(a) is a graph illustrating an impurity concentration profile of line Y1-Y2 in FIG. 2. FIG. 5(b) is a graph illustrating a potential profile corresponding to FIG. 5(a) (that is, potential profile of line Y1-Y2 in FIG. 2).

In FIGS. 4 and 5, “depth” represents a position in the direction parallel to line X1-X2 and line Y1-Y2. A positive direction of the “depth” is the direction from the p-well 22 to the n-type substrate 21. An upper surface of the p-well (surface opposite to n-type substrate 21) is set to a depth of 0.

In FIG. 4(a), the n-type region on the left side represents the sensing unit 1, the central p-type region represents the p-well 22, and the n-type region on the right side represents the n-type substrate 21, respectively. As illustrated in FIG. 4(a), a maximum value of the impurity concentration of the p-well 22 is a peak value C1 of the impurity concentration on line X1-X2 in FIG. 2 (that is, in the vicinity of the sensing unit 1). Hereinafter, the peak value of impurity concentration is also referred to as peak concentration.

In FIG. 5(a), the n-type region on the left side represents the vertical transfer unit 4, the central p-type region represents the p-well 22, and the n-type region on the right side represents the n-type substrate 21, respectively. As illustrated in FIG. 5(a), two different peak concentrations C2a and C2b (maximum values of impurity concentration) exist in the p-well 22 on line Y1-Y2 in FIG. 2 (that is, in the vicinity of the vertical transfer unit 4).

The reason is that the p-well 22 in the vicinity of the vertical transfer unit 4 is formed in two stages so that electrons are not injected into the vertical transfer unit 4 when electrons are injected from the n-type substrate 21 into the sensing unit 1.

Specifically, the peak concentration 2b (peak concentration at a position closer to the n-type substrate 21) is designed so as to be equal to the peak concentration C1. A preferable numerical range of the peak concentration C2b is similar to the following formula (1).

On the other hand, the peak concentration C2a (peak concentration at a position farther from the n-type substrate 21) is designed so as to be one order of magnitude or two orders of magnitude larger than that of the peak concentration C1. A preferable numerical range of the peak. concentration C2a is illustrated in the following formula (2).

That is, in the present embodiment, the p-well 22 in the vicinity of the vertical transfer unit 4 is formed so that C1=C2b<C2a. Therefore, on line Y1-Y2 in FIG. 2, the maximum value of the impurity concentration of the p-well 22 is the peak concentration C2a.

As a result, in the p-well 22 in the vicinity of the vertical transfer unit 4, since the number of holes which. are majority carriers is sufficiently large, even when electrons are injected from the n-type substrate 21 into the sensing unit 1, injection of electrons (free electrons) which are minority carriers is suppressed. The p-well 22 is formed in this manner, so that it is possible to appropriately perform the above-described process at the time of charge reading.

Incidentally, it. can. be understood that the junction. between the p-well 22 and the n-type substrate 21 is a pn junction. Accordingly, a large forward. bias voltage is applied. between the p-well 22 and the n-type substrate 21, so that it is considered that the electron injection from the n-type substrate 21 into the sensing unit 1 can be accelerated to the order of ns, for example.

As an example, in a case where the potential of the p-well 22 is 0 V, a large forward bias voltage is applied between the p-well 22 and the n-type substrate 21 by setting the voltage φOFD to a sufficiently small negative voltage.

That is, it is expected to accelerate the electron injection from the n-type substrate 21 into the sensing unit 1 by sufficiently reducing the value of the voltage φOFD. Here, in FIG. 4(b), the peak value of the potential of the p-well 22 (hereafter also referred. to as peak potential) is E1. In FIG. 4(b) and FIG. 5 described later, as illustrated in FIG. 4(b) representing voltage φOFD as potential Esub, when the potential Esub of the n-type substrate 21 is reduced smaller than the peak potential E1, the electron injection from the n-type substrate 21 into the sensing unit 1 is not inhibited by the potential barrier due to the peak potential E1. In this manner, when Esub<E1, the electron injection can be preferably performed.

However, in the ion sensor 100, restrictions exist in the lower value of the voltage φOFD. Therefore, it is difficult to sufficiently reduce the value of the voltage φOFD. The reason will be described below.

As described above, the vertical transfer unit 4 is required to be formed so that injection of electrons from the n-type substrate 21 does not occur when electrons are injected from the n-type substrate 21 into the sensing unit 1. Here, in FIG. 5(b), the peak potential of the p-well 22 is E2. Here, E1>E2.

However, as illustrated. in FIG. 5(b), in a case where the potential Esub is sufficiently reduced, Esub>E2. In this case, the injection of electrons from the n-type substrate 21 into the vertical transfer unit 4 is not inhibited by the potential barrier due to the peak potential E2.

Accordingly, when electrons are injected from the n-type substrate 21 into the sensing unit 1, electrons are also injected from the n-type substrate 21 to the vertical transfer unit 4, so that there arises a problem that the process at the time of charge reading cannot be appropriately performed. In order to prevent this problem, it is necessary to set Esub>P2.

Therefore, in the ion sensor 100, the range of the potential Esub needs to be set so as to satisfy the relationship E2<Esub<E1. Therefore, by sufficiently reducing the value of the voltage φOFD, it is impossible to accelerate the electron injection.

### Relationship between Peak Concentration C1 and Injection Time

Therefore, the inventor of the present application studied accelerating electron injection by a method other than sufficiently reducing the value of the voltage φOFD. As a result, it was newly found that injection time can be shortened by sufficiently reducing the peak concentration C1.

More specifically, the inventor of the present application has found that shortening of the injection time can be achieved by setting the value of C1 so as to satisfy the following formula (1), that is,

0<C1≤3.0×10¹⁴ cm⁻³ (1).

### Experimental Study

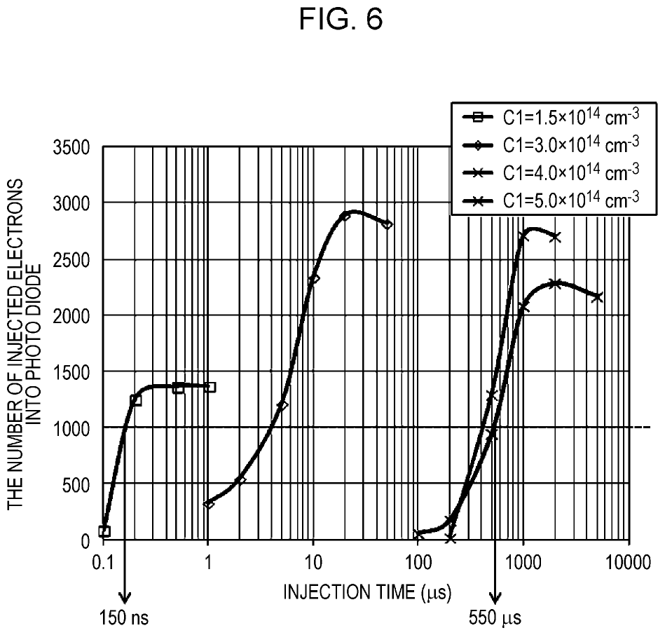

The inventor of the present application confirmed that the relationship between the injection time of electrons (signal charge) and the number of injected electrons for various C1 values in the ion sensor 100 by experiment. FIG. 6 is a graph (experimental result) illustrating the relationship between the injection time of electrons (signal charge) and the number of injected electrons. In this experiment, φOFD=−0.1 V and the impurity concentration of the n-type substrate 21 was 2.0×10¹⁴ cm⁻³.

In FIG. 6, a horizontal axis of the graph is injection time and a vertical axis of the graph is the number of electrons injected to the sensing unit 1 photodiode). In FIG. 6, experimental results on the four types of C1 values of “C=1.5×10¹⁴ cm⁻³”, “C1=3.0×10¹⁴ cm⁻”, “C1=4.0×10¹⁴ cm⁻³”, and “C1=5.0×10¹⁴ cm⁻³” are illustrated.

As illustrated in FIG. 6, it was confirmed that as the value of C1 was increased, the injection time for injecting a constant number of electrons increased. For example, in a case of C1=5.0×10¹⁴ cm⁻³, the injection time for injecting 1,000 electrons was approximately 550 μs.

On the other hand, in a case of C1=1.5×10¹⁴ cm⁻³, the injection time for injecting 1,000 electrons was approximately 150 ns. That is, the injection time can be reduced by approximately 3,600 times or higher as compared with the case of C1=5.0×10¹⁴ cm⁻³. Even in the case of C1=3.0×10¹⁴ cm⁻³, the injection. time for injecting 1,000 electrons was approximately um, and sufficient injection time reduction could. be realized.

It was confirmed that the number of injected electrons was saturated in a case where the injection time was lengthened in any values of C1. This is because the sensing unit 1 has reached saturation capacity (full capacity). The saturation capacity means an upper limit of the amount that can accommodate electrons from the n-type substrate 21 in the sensing unit 1.

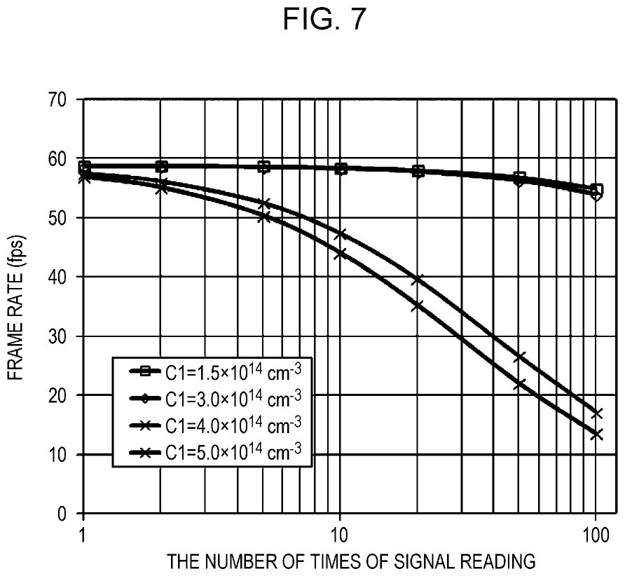

In addition, the inventor of the present application confirmed that the relationship between the number of signal reading and the frame rate with respect to the above-described four types of C1 values in the ion sensor 100 by experiment. FIG. 7 is a graph (experimental result) illustrating the relationship between the number of signal reading and the frame rate.

In FIG. 7, a horizontal axis of the graph is the number of signal reading (number of times 1,000 electrons accumulated in the sensing unit 1 are repeatedly read out). A vertical axis of the graph is a frame rate. The frame rate at the time of reading once was 60 fps.

As illustrated in FIG. 7, in a case where C1 is relatively large (that. is, in the case of C1=4.0×10¹⁴ cm⁻³ or C1=5.0×10¹⁴ cm⁻³), it was confirmed that the frame rate decreased as the number of signal reading increases.

On the other hand, in a case where C1 is sufficiently small (that is, in the case of C1=1.5×10¹⁴ cm⁻³ or C1=3.0×10¹⁴ cm⁻³), it was confirmed that the decrease in frame rate is sufficiently suppressed even in the case where the number of signal reading increases.

As described above, the inventor of the present application confirmed the validity of the numerical range of the peak concentration C1 illustrated in the formula (1) described above by experimental study.

### Theoretical Study

The inventor of the present application theoretically studied. the reason why the electron injection is accelerated by sufficiently reducing the peak concentration C1 as illustrated in the formula (1) described above. As a result, the following (first reason) and (second reason) were obtained.

### First Reason

As described above, in the vicinity of the sensing unit 1, it can be understood that the junction between the p-well 22 and the n-type substrate 21 is a pn junction. Accordingly, the built-in potential (diffusion potential) ΔV between the n-type substrate 21 and the p-well 22 is represented by the following formula (A). In formula (A), k is the Boltzmann constant, T is the absolute temperature, NA is the acceptor impurity concentration, ND is the donor impurity concentration, and ni is the intrinsic carrier density.

$$\begin{matrix}[ Math 1 ] & \\ Δ V = \frac{k T}{q} ln ( \frac{{N}_{A} {N}_{D}}{{n}_{i}^{2}} ) & ( A )\end{matrix}$$

Here, since the peak concentration C1 is the impurity concentration of the p-well 22 to which the acceptor is added as an impurity, a sufficiently small peak concentration C1 corresponds to a sufficiently small acceptor impurity concentration NA in formula (A).

Therefore, in a case where the peak concentration C1 is sufficiently small, the built-in potential ΔV also becomes sufficiently small. Accordingly, if the voltage φOFD is constant, by sufficiently reducing the peak concentration C1, the potential Vp of the p-well 22 can be increased. This is because Vp=φOFD−ΔV.

Accordingly, the electron injection from the n-type substrate 21 into the sensing unit 1 is less likely to be inhibited by a potential barrier due to the peak potential E1, and a high speed electron injection is enabled.

### Second Reason

In a case where a large forward bias voltage is applied between the n-type substrate 21 and the p-well 22, the diffusion length Ln of electrons (that is, minority carriers) in the p-well 22 (p-type region) is represented by the following formula (B). In formula (B), Dn is the diffusion coefficient of electrons, and τn is the lifetime of electrons.

[Math2]

Lₙ=\sqrt{Dₙτₙ} (B)

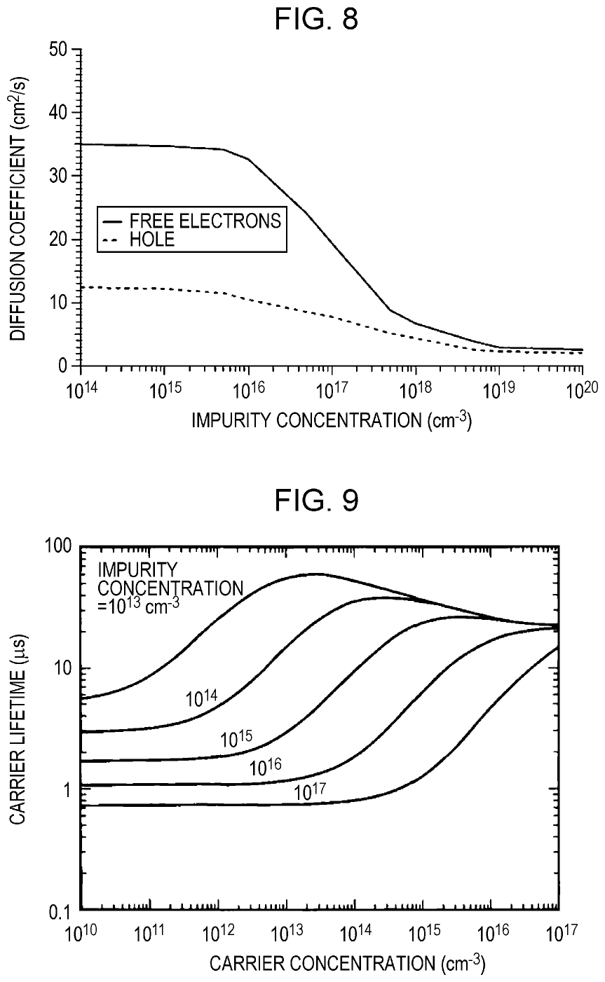

FIG. 8 is a graph illustrating a relationship between an impurity concentration of a semiconductor material and a diffusion coefficient. The graph of FIG. 8 is based on NPL 1 described above. According to FIG. 8, it is understood that the diffusion coefficient Dn is substantially constant irrespective of the value of the peak concentration C1 in a case where the peak concentration C1 (impurity concentration) is on the order of 10¹⁴ cm ⁻³.

FIG. 9 is a graph illustrating a relationship between a carrier concentration of the semiconductor material and a carrier lifetime. The graph of FIG. 9 is based on NPL 2 described above. According to FIG. 9, it is understood that the lifetime τn increases as the peak concentration C1 (impurity concentration) decreases.

Accordingly, as illustrated in the formula (1) described above, in a case where the peak concentration C1 is sufficiently reduced, the diffusion coefficient Dn remains substantially constant, and the lifetime τn sufficiently increases. Therefore, according to the formula (B), by sufficiently reducing the peak concentration C1, the diffusion length Ln can be sufficiently lengthened.

Accordingly, since electrons can be more easily injected from the n-type substrate 21 into the sensing unit 1, the high speed electron injection is enabled.

### Regarding Lower Limit Value of C1

Referring to the formula (1) described above, it is understood that C1=0 cm⁻³ is not included in the preferable numerical range of the peak concentration C1. This is because the p-well 22 becomes a neutral region in the case of C1=0 cm⁻³. In this case, this is because an unintended injection of electrons from the n-type substrate 21 into the sensing unit 1 via the neutral region may occur even at the time when the voltage φOFD=Middle (each time other than time b in FIG. 3).

### Effect of Ion Sensor 100

As described above, in the ion sensor 100 of the present embodiment, the peak concentration C1 is set so as to satisfy the formula (1) described above. That is, the impurity concentration in the p-well 22 is optimized. Therefore, it is possible to accelerate the injection of electrons into the sensing unit 1 without sufficiently reducing the value of the voltage φOFD.

Therefore, in the ion sensor 100, in order to improve the SN ratio of output, even in a case where the reading of the charges from the sensing unit 1 is repeatedly performed a plurality of times, high responsiveness can be realized. In this manner, according to the ion sensor 100, it is possible to achieve both improvement of the SN ratio of output and the high responsiveness.

### Preferable Numerical Range of Peak Concentration C2a

As described above, the peak concentration C2a is set so as to satisfy the relationship C2a>C2b=C1. The inventor of the present application also studied a preferable numerical range of the peak concentration C2a.

As a result, it was found that the preferable numerical range of the peak concentration C2a is represented by the following formula (2), that is,

1.5×10¹⁶ cm⁻³≤C2a≤3.5×10¹⁶ cm⁻³ (2).

Hereinafter, the basis of the numerical range is described.

First, the upper limit value of “C2a=3.5×10¹⁶ cm⁻³” is set in consideration of the transfer efficiency of the vertical transfer unit 4. In a case where the peak concentration C2a exceeds the upper limit value, a depletion layer is less likely to be formed in the n-type region on the surface of the vertical transfer unit 4 in response to the change of the voltages φV1 to φV4.

As an example, in a case where voltages φV1 to φV4 applied. to the vertical transfer unit 4 are operated at, for example, a frequency of 45 kHz, a transfer failure occurs in the vertical transfer unit 4. By setting the peak concentration C2a so as not to exceed the above-described upper limit value, it is possible to prevent such transfer failure.

The lower limit value of “C2a=1.5×10¹⁶ cm⁻³” is set so that injection of electrons into the vertical transfer unit 4 does not occur when electrons are injected from the n-type substrate 21 into the sensing unit 1 (for example, in a case of φOFD=−0.1 V)

In a case where the peak concentration C2a falls below the lower limit value, the injection into the electrons into the vertical transfer unit 4 starts in response to changes is the voltages φV1 to φV4. By setting the peak concentration C2a to be the above-described lower limit value or higher, the injection into the electrons into the vertical transfer unit 4 can be prevented.

### Embodiment 2

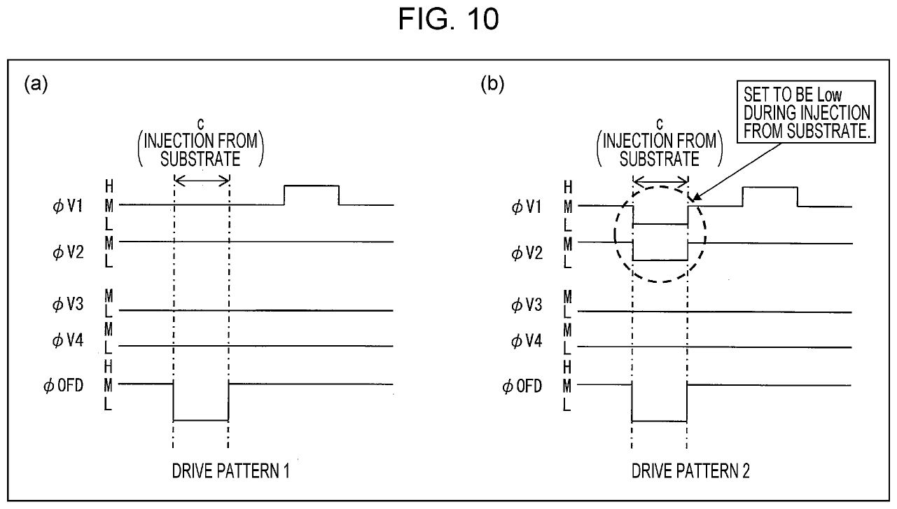

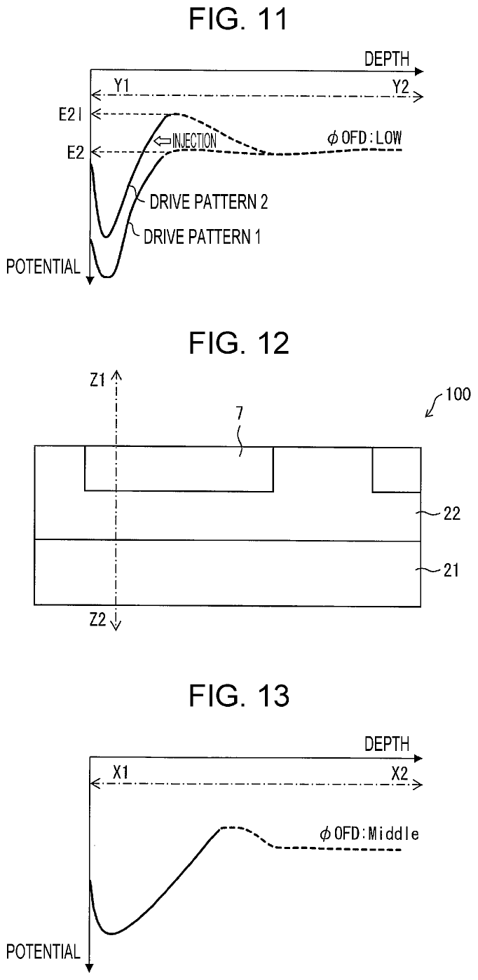

Embodiment 2 of the present invention will be described with reference to FIGS. 10 and 11 as follows. For convenience of description, members having the same functions as those described in the above embodiment are denoted by the same reference numerals, and description thereof will be omitted.

FIG. 10 are graphs illustrating drive patterns (waveforms of voltages φV1 to φV4 and φOFD) of the ion sensor 100 according to Embodiment 1 described above and the present embodiment, respectively. FIG. 10(a) is a graph it a drive pattern in Embodiment 1. For convenience, the drive pattern is referred to as drive pattern 1.

FIG. 10(a) may be understood to be a graph illustrating the vicinity of time c (injection time) in FIG. 3 described above. As illustrated in FIG. 10(a), the voltages φV1 and φV2 are Middle (0 V) and the voltages φV3 and φV4 are Low (−7 V to −6 V) at time c in the drive pattern 1.

FIG. 10(b) is a graph illustrating a drive pattern in the present embodiment. In order to distinction from the drive pattern 1 described above, the drive pattern is referred to as a drive pattern 2. As illustrated in FIG. 10(b), in the drive pattern 2, the voltages φV1 and φV2 also change to Low (−7 V to −6 V) at time c. That is, in the drive pattern 2, all of the voltages φV1 to φV4 are Low at time c. The drive pattern 2 is different from the drive pattern 1 at this point.

That is, in the drive pattern 2, a plurality of control voltages (voltages φV1 to φV4) for controlling the reading and transfer of signal charges are applied to the vertical transfer unit 4, and during electrons are injected from the n-type substrate 21 into the sensing unit 1 (that is, at time c, injection time), all of the plurality of control voltages are controlled so as to be at the lowest potential level (Low) among the predetermined plurality of potential levels (High, Middle, Low).

FIG. 11 is a graph illustrating potential profiles of line Y1-Y2 in FIG. 2 in a case of each drive pattern 1 and 2. Hereinafter, with reference to FIG. 11, advantages of the drive pattern 2 will be described.

Here, in FIG. 11, the peak potential in the potential profile of drive pattern 1 is the above-described peak potential E2 (refer to FIG. 5(b) described above). On the other hand, the peak potential E21 in the potential profile of the drive pattern 2 is smaller than the peak potential E2.

That is, by adopting the drive pattern 2, it is possible to lower the value of the peak potential compared to the drive pattern 1. This is because voltages φV1 to φVA which are Low in the drive pattern 2 are applied to a polysilicon electrode 25 provided on the upper portion of the vertical transfer unit 4. Therefore, the potential of the p-well 22 is influenced by the voltages φV1 to φV4 and decreases as compared with the drive pattern 1.

Accordingly, by adopting the drive pattern 2, electron injection from the n-type substrate 21 into the vertical transfer unit 4 can be preferably inhibited by the potential barrier due to the peak potential E21. Therefore, it is possible to more reliably prevent injection of electrons from the n-type substrate 21 into the vertical transfer unit 4 at the time of electron injection from the n-type substrate 21 into the sensing unit 1.

In the drive pattern 2, charges cannot be accumulated in the vertical transfer unit 4 at time c. Therefore, it should be noted that a plurality of times of charge reading from the sensing unit 1 to the vertical transfer unit 4 cannot be performed.

### Embodiment 3

Embodiment 3 of the present invention will be described with reference to FIGS. 12 to 15 as follows.

FIG. 12 is a cross-sectional view of a portion of an ion sensor 100. FIG. 12 schematically illustrates the configuration of the ion sensor 100 in the vicinity of the horizontal transfer unit 7. A polysilicon electrode (not illustrated) is provided above the horizontal transfer unit 7.

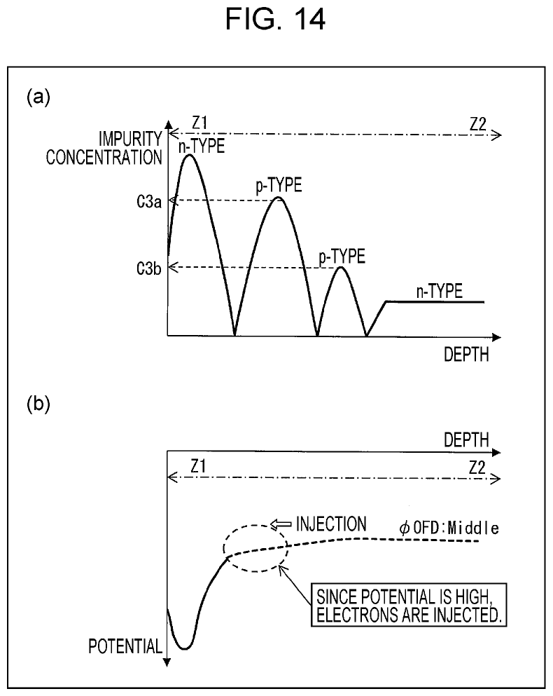

FIG. 14(a) is a graph illustrating an example of an impurity concentration profile of line Z1-Z2 in FIG. 12.

In FIG. 14(a), the n-type region on the left side represents the horizontal transfer unit 7, the central p-type region represents the p-well 22, and the n-type region on the right side represents the n-type substrate 21, respectively.

As illustrated in FIG. 14(a), on line Z1-Z2 in FIG. 12 (that is, in the vicinity of the horizontal transfer unit 7), two different peak concentrations C3a and C3b (maximum value of impurity concentration) exist in the p-well 22.

In the related art, the peak concentration C3b (peak concentration at a position closer to the n-type substrate 21) is designed so as to be equal to the peak concentration C1. The peak concentration C3a (peak concentration at a position farther from the n-type substrate 21) is designed so as to be one order of magnitude or two orders of magnitude larger than that of the peak concentration C1.

That is, in the related art, the peak concentration is set as C1=C3b<C3a.

FIG. 13 is a graph illustrating an example of a potential profile of line X1-X2 in FIG. 2. Specifically, FIG. 13 illustrates the potential profile in the case of line X1-X2 where φofd=Middle. Referring to FIG. 13, as described above, it is understood that injection of electrons from the n-type substrate 21 into the sensing unit 1 does not occur in the case of φofd=Middle.

On the other hand, FIG. 14(b) is a graph illustrating a potential profile corresponding to FIG. 14(a). Specifically, FIG. 14(b) illustrates the potential profile in the case of line Z1-Z2 where φofd=Middle,

Here, when FIG. 14(b) is compared. with FIG. 13, it is understood that the potential of the p-well 22 in the vicinity of the horizontal transfer unit 7 is higher than the potential of the p-well 22 in the vicinity of the vertical transfer unit 4.

This is because the impurity concentration of the horizontal transfer unit 7 is set to be higher than that of the sensing unit 1 and the vertical transfer unit 4 in order to further increase the saturation capacity as compared with the sensing unit 1 and the vertical transfer unit 4.

Therefore, in the vicinity of the horizontal transfer unit 7, a not injected density in the p-well 22 decreases as compared with the vicinity of the sensing unit 1 and the vertical transfer unit 4. Therefore, in the vicinity of the horizontal transfer unit 7, the potential of the p-well 22 increases as compared with the vicinity of the sensing unit 1 and the vertical transfer unit 4.

Accordingly, as illustrated. in FIG. 14(b), the injection of electrons from the n-type substrate 21 into the horizontal transfer unit 7 may occur even in the case of φofd=Middle. That is, in the design in the related art of C3b=C1, the injection of electrons from the n-type substrate 21 into the horizontal transfer unit 7 may occur even in the case of φofd=Middle.

As described above, φofd=Middle (5V to 20V) at the time of reading from the sensing unit 1 to the vertical transfer unit 4 (during vertical transfer). However, in the case of φofd=Middle, when the injection of electrons from the n-type substrate 21 into the horizontal transfer unit 7 occurs, the electrons transferred from the sensing unit 1 to the horizontal transfer unit 7 via the vertical transfer unit 4 are mixed with the electrons injected from the n-type substrate into the horizontal transfer unit 7.

Therefore, it is impossible to obtain the charge amount accumulated in the sensing unit 1 according to the change in ion concentration as the output of the ion sensor 100. In this manner, in the case of φofd=Middle, when the injection of electrons from the n-type substrate 21 into the horizontal transfer unit 7 occurs, there is a possibility that an appropriate operation of the ion sensor 100 is inhibited.

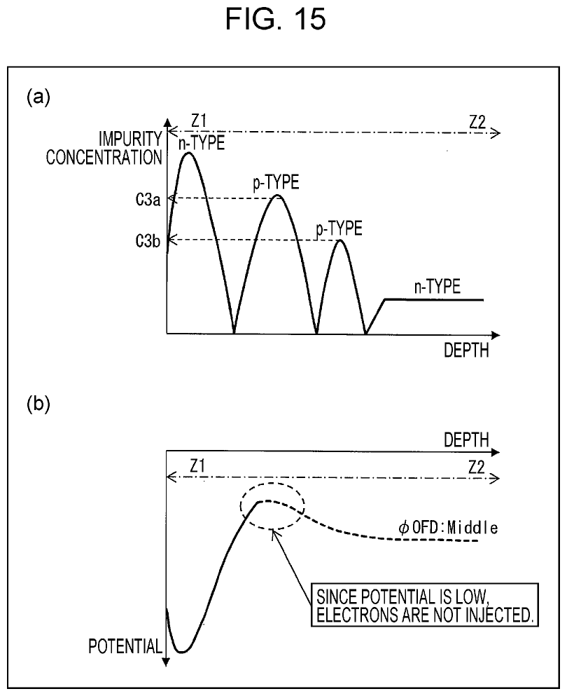

Based on the above points, the inventor of the present application has new found that reliability of the operation of the ion sensor 100 can be improved by setting the peak concentration as C3b>C1. Hereinafter, the configuration will be described with reference to FIG. 15.

FIG. 15(a) is a graph illustrating another example of the impurity concentration profile of line Z1-Z2 in FIG. 12. FIG. 15(a) is different from FIG. 14(a) described above in that peak concentration is set as C3b>C1. That is, in. the present embodiment, the peak concentration is set as C1<C3b<C3a.

The peak concentration C3a is set to be equal to the above-described peak concentration C2a. Accordingly, the preferable numerical range of the peak concentration C3a is the same as the above-described formula (2). In this manner, the maximum value of the impurity concentration of the p-well 22 is the peak concentration C3a on line Z1-Z2 in FIG. 12.

FIG. 15(b) is a graph illustrating a potential profile corresponding to FIG. 15(a). Specifically, FIG. 15(b) illustrates the potential profile of line Z1-Z2 in the case of φofd=Middle.

By setting C3b>C1, it is possible to increase the hole density in the p-well 22 in the vicinity of the horizontal transfer unit 7 as compared with the case of C3b=C1. Therefore, as illustrated in FIG. 15(b), the potential of the p-well 22 in the vicinity of the horizontal transfer unit 7 can be reduced as compared with the case of FIG. 14(b).

Accordingly, as illustrated in FIG. 15(b), injection of electrons from the n-type substrate 21 into the horizontal transfer unit 7 can be suppressed by setting C3b>C1 in the case of φofd=Middle.

In this manner, since the unintended injection of electrons from the n-type substrate 21 into the horizontal transfer unit 7 can be prevented by setting the peak concentration as C3b>C1, the charge amount accumulated in the sensing unit 1 according to the change in ion concentration can be obtained as the output of the ion sensor 100. That is, the reliability of the operation of the ion sensor 100 can be improved.

As described above, in the case of φofd=Low (−0.2 V to 0 V), vertical transfer is not performed. Accordingly, in the case of φofd=Low, even when electrons are injected from the n-type substrate 21 into the horizontal transfer unit 7, the electrons may be discharged from the horizontal transfer unit 7 to the output unit. By performing the vertical transfer after the discharge operation, the charge amount accumulated in the sensing unit 1 according to the change in ion concentration can be obtained as the output of the ion sensor 100.

### Preferable Numerical Range of Peak Concentration C3b

As described above, the peak concentration C3b is set so as to satisfy the relationship C1<C3b<C3a. The inventor of the present application also studied the preferable numerical range of the peak concentration C3b.

As a result, it was found that the preferable numerical range of the peak concentration C3b is represented by the following formula (3), that is,

C3b≥2.5×10¹⁴ cm⁻³ (3).

Hereinafter, the basis of the numerical range is described.

The lower limit value of “C3b=2.5×10¹⁴ cm ⁻³” is set so that the injection of electrons from the n-type substrate 21 into the horizontal transfer unit 7 does not occur in the case of φOFD=MIDDLE. The lower limit value is a lower limit value of the value of C3b in which he injection of electrons from the n-type substrate 21 into the horizontal transfer unit 7 does not occur in the case of φOFD=10 V.

That is, in the case of φOFD=MIDDLE, when the value of C3b falls below the lower limit value, it is understood that the injection of electrons into the horizontal transfer unit 7 occurs. By setting the peak concentration C3b to be the lower limit value or higher, the injection into the electrons into the horizontal transfer unit 7 can be prevented in the case of φOFD=MIDDLE.

### Summary on Relationship of Each Peak Concentration

In summary of Embodiments 1 to 3 above, the peak concentrations C1, C2a, C2b, C3a, and C3b may satisfy all relationships of the following (condition A) and the above-described formulas (1) to (3), that is

C1=C2b<C3b<C3a=C3b (condition A)

0<C1≤3.0×10¹⁴ cm⁻³ (1)

1.5×10¹⁶ cm⁻³≤C2a≤3.5×10¹⁶ cm⁻³ (2)

C3b≥2.5×10¹⁴ cm⁻³ (3).

### Embodiment 4

Embodiment 4 of the present invention will be described. with reference to FIGS. 16 to 18 as follows. In order to distinguish from the ion sensor 100 described above, the ion sensor of this embodiment is referred to as an ion sensor 400 (ion concentration sensor).

First, prior to the description of the ion sensor 400, improvement points of the ion sensor 100 will be described. FIG. 16(a) is a view schematically illustrating an overall configuration of the ion sensor 100. The ion sensor 100 is provided with a pixel region 91 and an n-type substrate contact unit 92.

The pixel region 91 is a region where the sensing unit 1 are alternately disposed in a matrix shape. The pixel region 91 may be, for example, a rectangular region. The n-type substrate contact unit 92 is a contact unit provided to connect the n-type substrate 21 to as external power source (not illustrated).

The n-type substrate contact unit 92 is formed on the outer periphery of the pixel region 91. This is because it is difficult to form the n-type substrate contact unit 92 in the pixel region 91 due to the size of the pixel region 91.

FIG. 16(b) is a partial cross-sectional view of the re-type substrate contact unit 92. As illustrated in FIG. 16(b), the voltage φOFD is applied to the n-type substrate 21 via the n+region 93. The n+region 93 is a portion of the n-type substrate contact unit 92 and is a region where an impurity concentration is, for example, 1.0×10¹⁹ cm⁻³ or higher.

In this manner, since the n+region 93 has an impurity concentration significantly larger than that of the n-type substrate 21, the resistance of the n-type substrate contact unit 92 is sufficiently smaller than that of the n-type substrate 21. Therefore, the voltage drop due to the resistance of the n-type substrate contact unit 92 can be reduced.

Here, refer to FIG. 16(a) again. In FIG. 16(a), a region near the center of the pixel region 91 is represented as a region Rc. A region near the outer periphery of the pixel region 91 is represented as a region Ro.

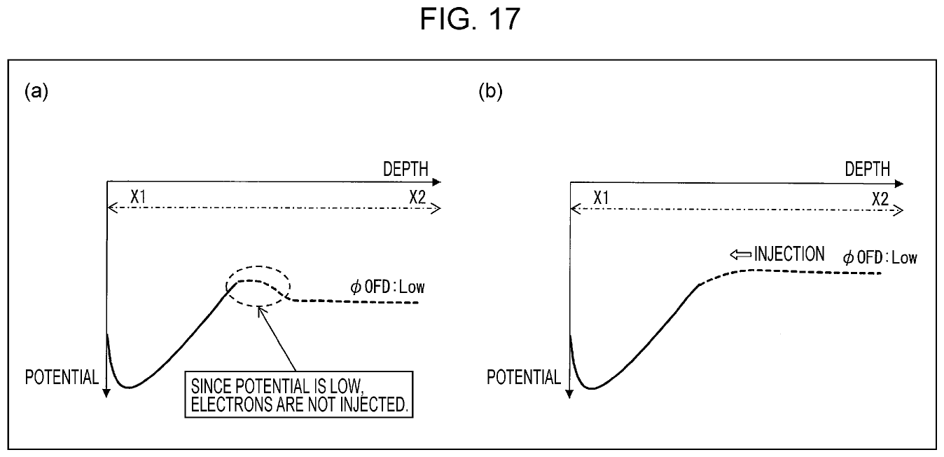

FIG. 17(a) is a graph illustrating a potential profile on line X1-X2 in FIG. 2 in the position Rc. FIG. 17(b) is a graph illustrating a potential profile on line X1-X2 in FIG. 2 in the position Ro.

As described above, since the region Ro is located near the outer periphery of the pixel region 91, the region Ro is relatively close to the n-type substrate contact unit 92. Accordingly, as illustrated in FIG. 17(b), the voltage drop due to the resistance of the n-type substrate 21 is relatively small in the region Rc. Therefore, in the region Ro, electrons are appropriately injected from the n-type substrate 21 into the sensing unit 1 in the case of φODF=Low.

On the other hand, since the region Rc is located near the center of the pixel region 91, the region Rc is distant from the n-type substrate contact unit 92 as compared with the region Ro. Accordingly, as illustrated in FIG. 17(a), in the region Rc, the influence of the voltage drop due to the resistance of the n-type substrate 21 becomes conspicuous.

Therefore, in the region Rc, there is a disadvantage that the electrons are not injected from the n-type substrate 21 into the sensing unit 1 even in the case of φODF=Low. Even when the electrons are injected from the n-type substrate 21 into the sensing unit 1 in the region Rc, the injection time becomes longer than that of the region Ro.

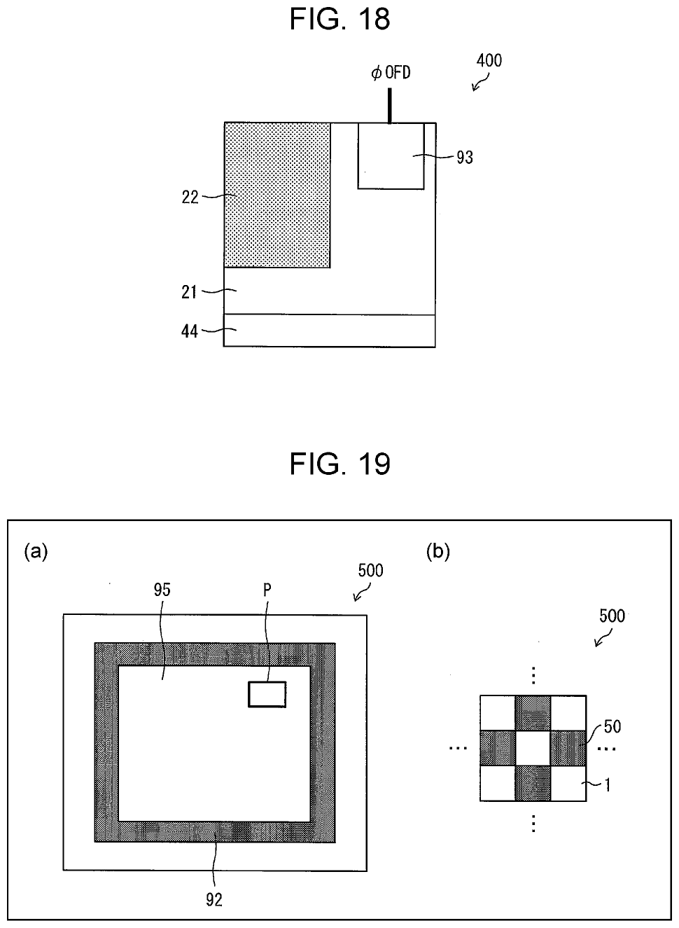

Subsequently, the ion sensor 400 of the present embodiment will be described. As described below, the ion sensor 400 is configured for the purpose of improving the injection of electrons from the n-type substrate 21 into the sensing unit 1 in the region Rc. FIG. 18 is a partial cross-sectional view of the n-type substrate contact unit 92 in the ion sensor 400 of the present embodiment.

As illustrated in FIG. 18, in the ion sensor 400 of the present embodiment, an n+layer 44 (doping layer) is provided on the n-type substrate 21. In FIG. 18, although a configuration in which the n+layer 44 is provided on the lower surface of the n-type substrate 21 is exemplified, the position where the n+layer 44 is provided is not limited thereto.

The n+layer 44 is a layer having a higher impurity (donor) concentration than that of the n-type substrate 21. In other words, the n+layer 44 is a layer in which a donor as an impurity is excessively added as compared with the n-type substrate 21.

More specifically, the impurity concentration of the n+layer 44 is 1.0×10¹⁹ cm⁻³ or higher. As described below, by providing the n+layer 44 on the n-type substrate 21, the resistance of the n-type substrate 21 decreases.

For example, in Embodiments 1 to 3, the impurity concentration of the n-type substrate 21 is 2.0×10¹⁴ cm⁻³. In this case, the resistivity of the n-type substrate 21 is approximately 20 Ω/cm. Accordingly, in case where the n-type region width of the n-type substrate 21 is 10 μm, the resistance (sheet resistance) of the n-type substrate 21 is approximately 20 MΩ.

On the other hand, as an example in this embodiment, a case where the impurity concentration of the n+layer 44 provided in the n-type substrate 21 is 1.0×10¹⁹ cm⁻³ is considered. In this case, the resistivity of the n+layer 44 is approximately 5.0×10⁻³ Ω/cm. In this manner, since the n+layer 44 has a very high impurity concentration as compared with the n-type substrate 21, the n+layer 44 has a sufficiently low resistivity as compared with the n-type substrate 21.

When the thickness of the n+layer 44 is 5 nm, the resistance (sheet resistance) of the n-type substrate 21 is approximately 1 kΩ. In this manner, by providing the n+layer 44, the resistance of the n-type substrate 21 can be significantly reduced (approximately 5.0×10⁻⁵ times).

Accordingly, according to the ion sensor 400, the influence of the voltage drop due to the resistance of the n-type substrate 21 can be sufficiently reduced in the region Rc. Accordingly, in the ion sensor 400, a profile (refer to FIG. 17(a) described above) of the same potential as the region Ro can be obtained also in the region Rc.

Therefore, in the case of φODF=Low, the injection of electrons from the n-type substrate 21 into the sensing unit 1 can be reliably performed also in the region Rc. It is also possible to shorten the injection time of electrons in the region Rc. As described above, according to the ion sensor 400 of the present embodiment, the injection of electrons from the n-type substrate 21 to the sensing unit 1 can be improved in the region Rc.

### Embodiment 5

Embodiment 5 of the present invention will be described with reference to FIGS. 19 to 21 as follows. FIG. 19(a) is a view schematically illustrating the overall configuration of the ion sensor 500 (ion concentration sensor) of the present embodiment. The ion sensor 500 is obtained by replacing the pixel region 91 with the pixel region 95 in the ion sensor 100 of FIG. 16(a) described above.

FIG. 19(b) is an enlarged view of a region P of FIG. 19(a). Here, the region P is a partial region in the pixel region 95. The position of the region P is not particularly limited. As illustrated in FIG. 19(b), in the pixel region 95, the sensing unit 1 described above and a sensing unit 50 (second sensing unit) described below are alternately disposed in a matrix shape.

In order to distinguish between the sensing unit 1 and the sensing unit 50, (i) the sensing unit 1 may be referred to as a substrate injection pixel, and (ii) the sensing unit 50 may be referred to as a light irradiation pixel, respectively.

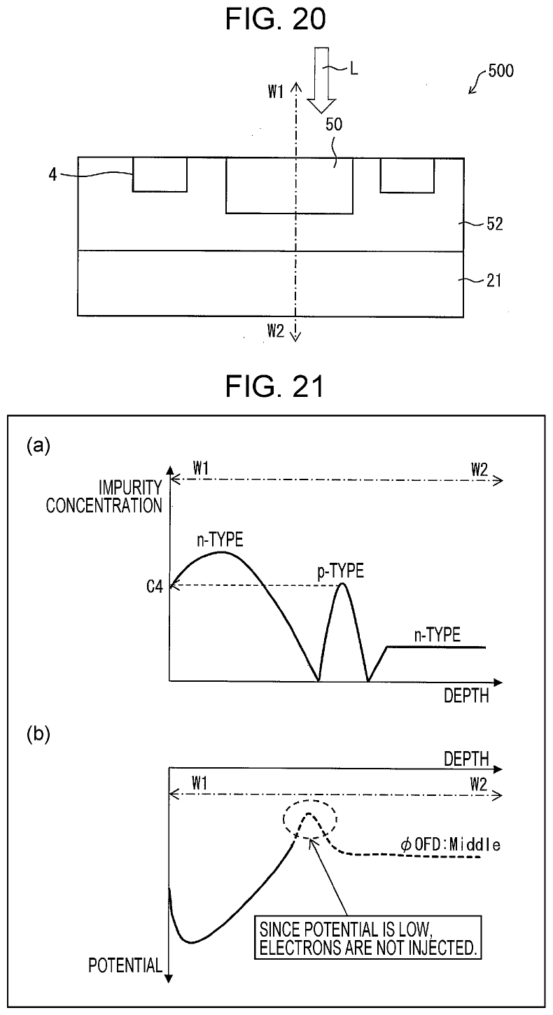

FIG. 20 is a cross-sectional view illustrating a structure of the sensing unit 50. FIG. 20 schematically illustrates a configuration of one pixel of the ion sensor 500. As illustrated in FIG. 20, the configuration. around the sensing unit 50 is substantially the same as that in FIG. 3 described above. In order to distinguish from FIG. 3 described above, a p-well in contact with the sensing unit 50 is represented as a p-well 52.

The p-well 52 is different from the p-well 22 in that the value of the peak concentration C4 (maximum value of the impurity concentration) is larger than the value of the peak concentration C1 of the p-well 22. That is, the p-well 52 is a p-type diffusion region formed so as to have a higher impurity concentration than that of the p-well 22.

In this manner, in the present embodiment, C4 is set so as to satisfy the following formula (4)

C1<C4 (4).

As an example, C4=8.0×10¹⁴ cm⁻³.

The sensing unit 50 is an n-type diffusion region similar to the sensing unit 1 described above. Accordingly, the sensing unit 50 can function as a photoelectric conversion unit. Therefore, the sensing unit 50 can receive the light L and convert the light L into electric charge.

Accordingly, in the ion sensor 500, an image (for example, color image or monochrome image) corresponding to the light L can be obtained by disposing the sensing units 50 in a matrix shape. That is, the sensing unit 50 can function as an image capturing element that receives the light L and captures an image. In this manner, it is possible to add a function of optically capturing the inspection target to the ion sensor 500 by providing the sensing unit 50.

FIG. 21(a) is a graph illustrating a profile of the impurity concentration of portion W1-W2 in FIG. 20. FIG. 21 (b) is a graph illustrating the potential profile corresponding to FIG. 21(a) (that is, potential profile of line W1-W2 in FIG. 20).

When FIG. 21(a) is compared with. the FIG. 4(a) described above, it is understood that the formula (4) described above is satisfied. As illustrated in formula (4), the following (advantage 1) and (advantage 2) are obtained by making C4 larger than C1.

(Advantage 1): The potential of the p-well 52 can be lower than the potential of the p-well 22. Therefore, even in a case where electrons are injected from the n-type substrate 21 into the sensing unit 1, electrons are not injected from the n-type substrate 21 into the sensing unit 50. Accordingly, it is possible to prevent the image obtained by the sensing unit 50 from being adversely affected by injection of electrons from the n-type substrate 21.

When FIG. 21(b) is compared with FIG. 13 described above, it can be understood that the potential of the p-well 52 is lower than the potential of the p-well 22.

(Advantage 2): Since the potential of the p-well 52 can be lowered, the saturation capacity of the sensing unit 50 can be increased. The saturation capacity of the sensing unit 05 means the upper limit of the amount that the sensing unit 50 can accommodate charges (electrons) generated by converting light. Accordingly, it is possible to improve the accuracy of the image obtained by the sensing unit 50.

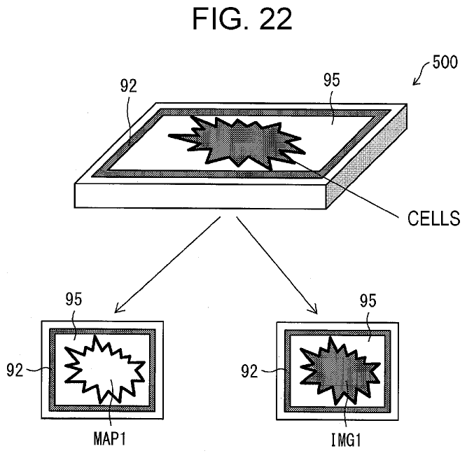

FIG. 22 is a view illustrating an example of the operation of the ion sensor 500. In FIG. 22, cells disposed on the pixel region 95 are exemplified as measurement targets. As an example, it is possible to confirm an aspect of biological activity of the cell by measuring an ion concentration distribution (that is, spatial distribution of pH) of a liquid secreted from a lying body such as a cell.

As described above, in the ion sensor 500, the sensing unit 1 and the sensing unit 50 (that is, substrate injection pixel and light irradiation pixel) are alternately disposed in a matrix shape.

Therefore, as illustrated in FIG. 22, it is possible to detect the ion concentration distribution MAP 1 of the inspection target by the sensing unit 1 disposed in the matrix shape. In addition, it is possible to capture the image IMG 1 of the inspection target by the sensing unit 50 disposed in the matrix shape.

That is, according to the ion sensor 500, it is possible to simultaneously acquire she ion concentration distribution MAP 1 and the image IMG 1 for the inspection target. It is possible to acquire the image IMG 1 at a position substantially coinciding with the ion concentration distribution MAP 1.

Therefore, it is easy to allow the user to observe the ion concentration distribution MAP 1 while allowing the user to confirm the image IMG 1. Therefore, the convenience of the user observing the measurement target can be improved.

### SUMMARY

An ion concentration sensor (ion sensor 100) according to Aspect 1 of the present invention is an ion concentration sensor that detects an ion concentration of a measurement target based on a potential change on a surface of a sensing unit (1) sensitive to ions, and includes a substrate (n-type substrate 21) to which a donor is added as an impurity and a p- well (22) that is added with an acceptor as an impurity and laminated on the substrate. The sensing unit includes a donor added as an impurity and. accumulates an electron injected from the substrate via the p-well as a signal charge. A concentration distribution of impurities exists in. the p-well located between. the sensing unit and. the substrate, and the maximum value C1 (peak concentration C1) of the impurity concentration in the p-well satisfies the following formula (A1)

0<C1≤3.0×10¹⁴ cm⁻³ (A1).

According to the above configuration, the maximum. value C1 of the impurity concentration of the p-well located between the sensing unit and the substrate (p-well located in the vicinity of line X1-X2 in FIG. 2 described above) is sufficiently small. As described above, the inventor of the present application. has found that injection of signal charges (electrons) from the substrate into the sensing unit is accelerated by setting the value of C1 so as to satisfy the formula (A1) through experimental study and theoretical examination, (in particular, refer to FIGS. 6 and 7).

Accordingly, according to this configuration, by optimizing the impurity concentration in the p-well, it is possible to accelerate the supply of the signal charge to the sensing unit. Therefore, high responsiveness can be realized even in a case where signal charge reading from the sensing unit is repeatedly performed a plurality of times in order to improve the SN ratio of the output in the ion concentration sensor.

As described above, according to the ion concentration sensor of one aspect of the present invention, there is an effect that both improvement of the SN ratio of output and high responsiveness can be achieved.

It is preferable that the ion concentration sensor according to Aspect 2 of the present invention in Aspect 1 further includes a vertical transfer unit (4) that reads and transfers the signal charge accumulated in the sensing unit, in which the vertical transfer unit to which a donor is added. as an impurity is formed on a side apart from the substrate of the p-well, and a concentration distribution. of impurities exists in the p-well located between the vertical transfer unit and the substrate, and. a maximum value C2a of the impurity concentration (peak concentration C2a) in the p-well satisfies a following formula (A2)

1.5×10¹⁶ cm⁻³≤C2a≤3.5×10¹⁶ cm⁻³ (A2).

According to the above configuration, the maximum value C2a of the impurity concentration of the p-well located between the vertical transfer unit and the substrate (p-well located in the vicinity of line Y1-Y2 in FIG. 4 described above) is set so as to satisfy the formula (A2). Therefore, as described above, there is an effect that it is possible to prevent a transfer defect in the vertical transfer unit and to prevent injection into the electron from the substrate into the vertical transfer unit.

In the ion concentration sensor according to Aspect 3 of the present invention in Aspect 2, it is preferable that a plurality of control voltages (voltages φV1 to φV4) for controlling the reading and transfer of the signal charge are applied to the vertical transfer unit, and all of the plurality of control voltages are controlled so as to be the lowest potential level among a plurality of predetermined potential levels whole the electron. is injected from the substrate into the sensing unit.

Accord ng to the above configuration, since all of the plurality of control voltages are at the lowest potential level, the peak potential in the p-well located between the vertical transfer unit and the substrate (p-well located. in the vicinity of line Y1-Y2 in FIG. 4 described above) can be lowered. Therefore, there is an effect that it is possible to more reliably prevent the injection of electrons from the substrate into the vertical transfer unit when electrons are injected from the substrate into the sensing.

It is preferable that the ion concentration sensor according to Aspect 4 of the present invention in Aspect or 3 further includes a horizontal transfer unit (7) that transfers the signal charge transferred from the vertical transfer unit to an output unit of the ion concentration sensor, in which the horizontal transfer unit to which a donor is added as an impurity is formed on the side apart from the substrate of the p-well, and a concentration. distribution of impurities exists in the impurity concentration of the p-well located between the horizontal transfer un it and the substrate, and when a smaller peak value among two peak values of the impurity concentration in the p-well is C3b (peak concentration C3b), the peak. value C3b satisfies following formulas (A3) and (A4)

C1<C3b<C2a (A3)

C3b≥2.5×10¹⁴ cm⁻³ (A4)

According to the above configuration, the peak value C3b (smaller peak value) of the impurity concentration of the p-well located between the horizontal transfer unit and the substrate (p-well located in the vicinity of line Z1-Z2 in FIG. 12 described above) is set so as to satisfy the formulas (A3) and (A4). Therefore, as described above, it is possible to suppress injection of electrons from the substrate into the horizontal transfer unit.

Accordingly, it is possible to obtain the charge amount of the electrons accumulated in the sensing unit according to the change in the ion concentration as the output of the ion sensor. That is, there is an effect that it is possible to improve the reliability of the operation of the ion sensor.

In the ion concentration sensor according to Aspect 5 of the present invention in any one of Aspects 1 to 4, it is preferable that the substrate is provided with a doping layer (n+layer 44) in which a donor is excessively added as an impurity as compared with the substrate, and the impurity concentration of the doping layer is 1.0×10¹⁹ cm⁻³ or more.

According to the above configuration, the resistance of the substrate can be sufficiently reduced. Therefore, there is an effect that it is possible to sufficiently reduce the influence of the voltage drop due to the resistance of the substrate, and to improve the injection of electrons from the substrate into the sensing unit.

It is preferable that the ion concentration sensor according to Aspect 6 of the present invention in any one of Aspects 1 to 5 further includes a second sensing unit (sensing unit 50) that accumulates an electron generated by photoelectric conversion as a signal charge, in which the second sensing unit includes a donor added as an impurity and is formed on the side apart from the substrate of the p-well, and a concentration distribution of impurities exists in the p-well located between the second sensing unit and the substrate, and a maximum value C4 (peak concentration. C4) of the impurity concentration in the p-well satisfies a following formula (A5)

C1<C4 (A5).

According to the above configuration, the second sensing unit can function as an image capturing element that receives light and captures an image (pictorial image). In addition, the maximum position C4 of the impurity concentration of the p-well located between the second sensing unit and the substrate (p-well located in the vicinity of line W1-W2 in FIG. 20 described above) is set so as to satisfy the formula (A5). Therefore, as described above, even in a case where electrons are injected from the substrate into the sensing unit, the electrons are not injected from the substrate into the second sensing unit.

Accordingly, there is an effect that it is possible to prevent the image obtained by the second sensing unit from being adversely affected by the injection of electrons from the substrate.

In the ion concentration. sensor according to Aspect 7 of the present invention in Aspect 6, it is preferable that the sensing unit and the second sensing unit are alternately disposed in a matrix shape.

According to the above configuration, the ion concentration distribution of the inspection target can be detected by the sensing unit. The second sensing unit can capture the image of the inspection target. Furthermore, since the sensing unit and the second sensing unit are alternately disposed in the matrix shape, an image at a position substantially coinciding with the ion concentration distribution can be obtained. Therefore, there is an effect that it is possible to improve the convenience of the user observing the measurement target.

### Additional Notes

The present invention is not limited to the above-described embodiments, and various modifications are possible within the scope indicated in the claims, and embodiments obtained by appropriately combining technical means respectively disclosed in different embodiments are also included in he technical scope of the present invention. Furthermore, by combining technical means respectively disclosed in each embodiment, new technical features can be formed.

### CROSS REFERENCE TO RELATED APPLICATIONS

This application claims the benefit of priority to Japanese Patent Application: Japanese Patent Application No. 2015-232215 filed on Nov. 27, 2015, and the entire contents of which are incorporated herein by reference thereto.

### REFERENCE SIGNS LIST

1 sensing unit
4 vertical transfer unit
7 horizontal transfer unit
21 n-type substrate (substrate)
22, 52 p-well
44 n+ layer (doping layer)
50 sensing unit (second sensing unit)
100, 400, 500 ion sensor (ion concentration sensor)
C1, C2a, C3a, C4 peak concentration (maximum value of impurity concentration)
C2b, C3b peak concentration (peat value of impurity concentration)
φV1 to φV4 voltage (control voltage)

1. An ion concentration sensor that detects an ion concentration of a measurement target based on a potential change on a surface of a sensing unit sensitive to ions, comprising:
a substrate to which a donor is added as an impurity; and
a p-well to which an acceptor is added as an impurity and that is laminated on the substrate,
wherein the sensing unit includes a donor added as an impurity and accumulates an electron injected from the substrate via the p-well as a signal charge, and
a concentration distribution of impurities exists in the p-well located between the sensing unit and the substrate, and a maximum value C1 of an impurity concentration in the p-well satisfies a following formula (A1)
0<C1≤3.0×10¹⁴ cm⁻³ (A1)

2. The ion concentration sensor according to claim 1, further comprising:
a vertical transfer unit that reads and transfers the signal charge accumulated in the sensing unit,
wherein the vertical transfer unit to which a donor is added as an impurity is formed on a side apart from the substrate of the p-well, and
a concentration distribution of impurities exists in the p-well located between the vertical transfer unit and the substrate, and a maximum value C2a of the impurity concentration in the p-well satisfies a following formula (A2)
1.5×10¹⁶ cm⁻³≤C2a≤3.5×10¹⁶ cm⁻³ (A2).

3. The ion concentration sensor according to claim 2, further comprising:
a horizontal transfer unit that transfers the signal charge transferred from the vertical transfer unit to an output unit of the ion concentration sensor,
wherein the horizontal transfer unit to which a donor is added as an impurity is formed on the side apart from the substrate of the p-well, and
a concentration distribution of impurities exists in the p-well located between the horizontal transfer unit and the substrate, and when a smaller peak value among two peak values of the impurity concentration in the p-well is C3b, the peak value C3b satisfies following formulas (A3) and (A4)
C1<C3b<C2a (A3)
C3b≥2.5×10¹⁴ cm⁻³ (A4)

4. The ion concentration sensor according to claim 1, further comprising:
a second sensing unit that accumulates an electron generated by photoelectric conversion as a signal charge,
wherein the second sensing unit includes a donor added as an impurity and is formed on the side apart from the substrate of the p-well, and
a concentration distribution of impurities exists in the p-well located between the second sensing unit and the substrate, and a maximum value C4 of the impurity concentration in the p-well satisfies a following formula (A5)
C1<C4 (A5).

5. The ion concentration sensor according to claim 2, further comprising:
a second sensing unit that accumulates an electron generated by photoelectric conversion as a signal charge,
wherein the second sensing unit includes a donor added as an impurity and is formed on the side apart from the substrate of the p-well, and
a concentration distribution of impurities exists in the p-well located between the second sensing unit and the substrate, and a maxim urn value C4 of the impurity concentration in the p-well satisfies a following formula (A5)
C1<C4 (A5).

6. The ion concentration sensor according to claim 3, further comprising:
a second sensing unit that accumulates an electron generated by photoelectric conversion as a signal charge,
wherein the second sensing unit includes a donor added as an impurity and is formed on the side apart from the substrate of the p-well, and
a concentration distribution of impurities exists in the p-well located between the second sensing unit and the substrate, and a maximum value C4 of the impurity concentration in the p-well satisfies a following formula (A5)
C1<C4 (A5).
